(19) United States
(12) Patent Application Publication
(10) Pub. No.: US 2018/0048576 A1
(43) Pub. Date: Feb. 15, 2018

(54) PACKET TRANSMISSION

(71) Applicant: HANGZHOU H3C TECHNOLOGIES CO., LTD., Hangzhou (CN)

(72) Inventors: Yancheng Xu, Beijing (CN); Wei Wang, Beijing (CN)

(21) Appl. No.: 15/555,662

(22) PCT Filed: Mar. 29, 2016
(86) PCT No.: PCT/CN2016/077629

§ 371 Date: Sep. 5, 2017

(30) Foreign Application Priority Data
Mar. 31, 2015 (CN) 201510151219.6

(51) Int. Cl. H04L 12/851; H04L 12/24

(52) U.S. Cl. CPC H04L 47/24; H04L 41/5019

(57) ABSTRACT

A method for transmitting a packet is disclosed. An intermediate device in a network may acquire, after receiving a service packet of a target service from a server in the network, a guaranteed bandwidth of the target service corresponding to service information of the target service according to the service information carried in the service packet. Then the intermediate device may transmit the service packet of the target service according to the guaranteed bandwidth.

### BACKGROUND

The disclosure relates to network communication, especially to a method and device for transmitting a packet.

In a large-scale data center, more than one physical device such as a server may be deployed. Through virtualization technology, multiple virtualization platforms may be virtually constructed on a hardware platform of any physical device, and each of the virtualization platforms may correspond to a virtual machine (VM). And at least one service may be operated on each VM.

When transmitting service packets for different services, an intermediate device on a network may identify service packets from the same physical device and allocate a transmission bandwidth in a unit of a physical device. When multiple traffic flows corresponding to different services are transmitted from the same physical device concurrently, the different services may obtain an equal transmission bandwidth if a transmission bandwidth is allocated in a unit of a physical device. However, different types of services may have different demands for transmission resource. For example, video service having a high real-time requirement may have a greater demand for transmission resource than that for file transmission service.

### BRIEF DESCRIPTION OF THE DRAWINGS

FIG. 1 is a schematic diagram illustrating packet transmission in a SDN according to an example of the disclosure;

FIG. 2 is a flowchart illustrating a method for transmitting a packet according to an example of the disclosure;

FIG. 3 is a flowchart illustrating a method for transmitting a packet according to another example of the disclosure;

FIG. 4 is a flowchart illustrating a method for transmitting a packet according to another example of the disclosure;

FIG. 5 schematically illustrates hardware structure of an apparatus on which a device for transmitting a packet according to an example of the disclosure is located;

FIG. 6 is a block diagram illustrating a device for transmitting a packet according to an example of the disclosure; and

FIG. 7 is a block diagram illustrating a device for transmitting a packet according to another example of the disclosure.

### DETAILED DESCRIPTION OF THE EMBODIMENTS

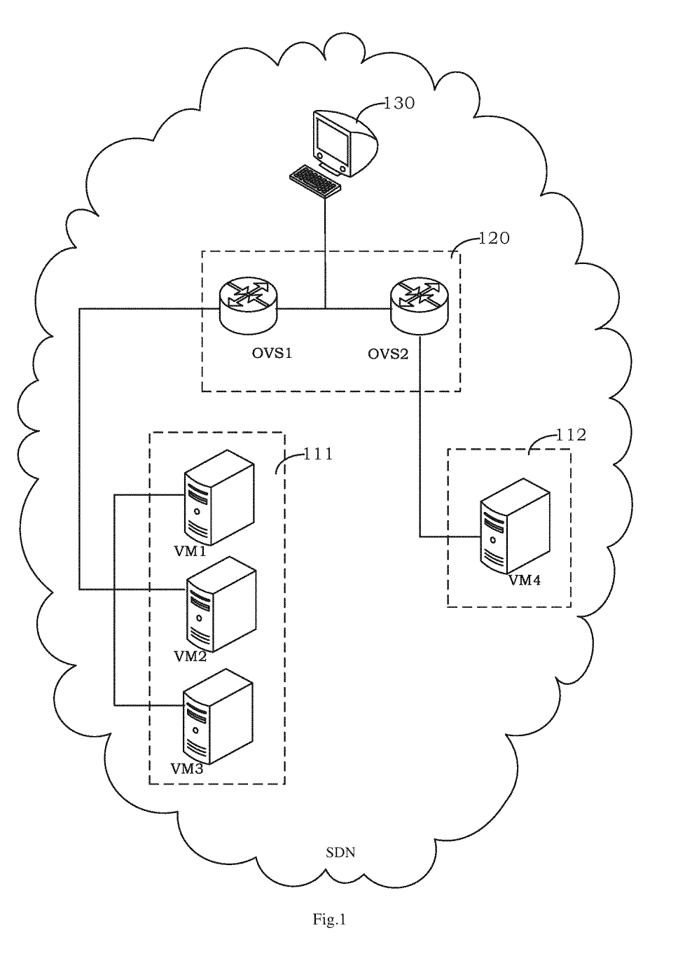

Hereinafter, examples according to the disclosure will be described with reference to the drawings. Firstly, see FIG. 1, which is a schematic diagram illustrating packet transmission in a SDN according to an example of the disclosure.

In FIG. 1, a Software Defined Network (SDN) is taken as an example for description. In the SDN architecture, servers 111 and 112 may transmit a packet to each other based on Open Flow protocol. And wherein, the servers 111 and 112 may be connected with a controller 130 through an intermediate device 120. The intermediate device 120 may be a physical gateway having a switching function or may be a physical device provided with one or more Open Virtual Switches (OVSs). As illustrated in FIG. 1, the intermediate device 120 may be provided with an OVS 1 and an OVS 2. Each of the servers may be provided with one or more virtual machines (VMs). As illustrated in FIG. 1, the server 111 may be provided thereon with a VM 1, a VM 2 and a VM 3, and connected with the controller 130 via the OVS 1. The server 112 may be provided with a VM 4, and connected with the controller 130 via the OVS 2. And wherein, each of the VMs may be installed with a different application (APP) to operate a different service. The service may include data synchronous-exchange service, video service and file transmission service, etc. The controller 130 may allocate corresponding guaranteed bandwidths according to demands for transmission resource with respect to different services by registering the services on the controller 130. For example, a service having a high demand for transmission resource may be allocated with a greater guaranteed bandwidth, such that the demands for transmission resource of different services may be satisfied respectively. Thus the transmission performance for service packets may be improved and services may be prevented from interruption.

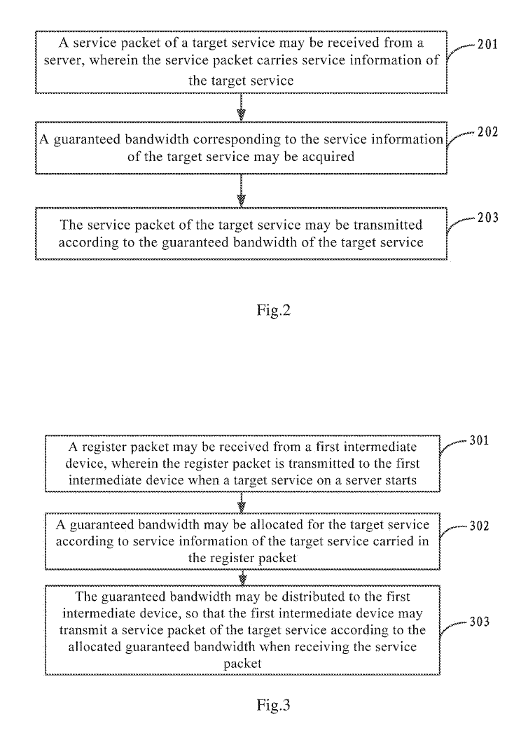

Next, refer to FIG. 2 which is a flowchart illustrating a method for transmitting a packet according to an example of the disclosure. This example may give description from the intermediate device side, and the description may include the following blocks.

At block 201, a service packet of a target service may be received from a server, wherein the service packet carries service information of the target service.

In this example, one or more servers may transmit a service packet via the intermediate device, and one or more services may be operated on each of the servers. The example may focus on a target service operated on some server to describe a packet transmission process. The target service may generate a service packet corresponding to its service type during operation. For example, when the target service is a video service, a video service packet may be generated.

The service information of the target service may include the Internet Protocol (IP) address and the Media Access Control (MAC) address of the server which operates the target service, and the port number of the target service.

At block 202, a guaranteed bandwidth corresponding to the service information of the target service may be acquired.

In this example, each of the services including the target service may transmit a register packet to the controller via the intermediate device when started, and then the controller may allocate a guaranteed bandwidth to each service according to the register packet. In an optional manner, the controller may acquire service information carried in the register packet of the target service, and acquire a service priority preset for the target service according to the service information, such that the controller may allocate a guaranteed bandwidth to the target service according to the proportion of the service priority of the target service in the sum of the service priorities of all registered services. In another optional manner, after acquiring the service information carried in the register packet of the target service, the controller may acquire a COST value of the target service corresponding to the service information, such that the controller may allocate a guaranteed bandwidth to the target service according to the proportion of the COST value in the sum of the COST values of all registered services. No matter whether the controller allocates the guaranteed bandwidth to the target service according to the service priority or the COST value, the guaranteed bandwidth is correspondingly allocated to the target service according to the weight of transmission demand for the target service in those for all the registered services, or in other words, the importance grade of the target service in all the registered services.

When the controller distributes to the intermediate device the guaranteed bandwidth allocated for the target service, the intermediate device may establish a forward entry for the target service in a preset forward priority table, and the forward entry may include correspondence between the service information of the target service and the guaranteed bandwidth. Thus, when the intermediate device receives a service packet of the target service, the intermediate device may acquire the service information of the target service from the received service packet, determine the forward entry for the target service from the forward priority table according to the service information of the target service, and acquire the guaranteed bandwidth of the target service according to the forward entry.

At block 203, the service packet of the target service may be transmitted according to the guaranteed bandwidth of the target service.

According to an example, when the intermediate device acquires the guaranteed bandwidth of the target service, the service packet of the target service may be transmitted according to the guaranteed bandwidth of the target service. In this way, the transmission performance for the service packet of the target service may be guaranteed by the guaranteed bandwidth such that the target service can be guaranteed without interruption.

Combining with the above-described example, in an optional manner, when the above-described target service shuts down, the server may transmit a deregister packet of the target service to the intermediate device, and the intermediate device may forward the deregister packet to the controller. The deregister packet may carry the service information of the target service, and the controller may learn from the deregister packet that the target service no longer needs the guaranteed bandwidth. Then, the controller may inform the intermediate device to release the guaranteed bandwidth allocated for the target service while the guaranteed bandwidth for a remaining service is unchanged. Here the remaining service includes a service registered on the controller through the intermediate device other than the target service. Or the controller may reallocate a guaranteed bandwidth for a remaining service according to the service information in the deregister packet, for example, the guaranteed bandwidth of the target service may be reallocated to a remaining service according to a different priority of the remaining service. When reallocating a guaranteed bandwidth for a remaining service, the controller may distribute the reallocated guaranteed bandwidth to the intermediate device, and the intermediate device may update the forward entry of the remaining service in the forward priority table according to the reallocated guaranteed bandwidth.

Combining with the above-described example, in another example, the intermediate device may monitor a hitting number for each of different services, wherein, the hitting number for a service indicates how many times the forward entry in a forward priority table corresponding to the service is hit by service packets of the service in a preset period. When the intermediate device monitors an abnormal service of which the hitting number is not within a preset range, the intermediate device may transmit a notification message to the controller. The controller may adjust the guaranteed bandwidth of the abnormal service according to the received notification message, and may further adjust the guaranteed bandwidths of all the services of which service packets are transmitted via the intermediate device. And wherein, when the intermediate device monitors an abnormal service of which the hitting number is lower than the lower limit of the preset range, it indicates that the abnormal service has a very little flow or even has no packet flow in the preset period. Then the controller may reduce the guaranteed bandwidth of the abnormal service and further allocate the reduction in the guaranteed bandwidth to other normal services of which service packets may be transmitted via the intermediate device. When the intermediate device monitors an abnormal service of which the hitting number is higher than the upper limit of the preset range, it indicates that the abnormal service has a large packet flow in the preset period. Then the controller may increase the guaranteed bandwidth for the abnormal service, and may further correspondingly reduce the guaranteed bandwidths of other normal services of which service packets are transmitted via the intermediate device.

It can be seen from the above-described example that, since service information may reflect transmission resource demands for different services, the controller may allocate proper guaranteed bandwidths to the services according to service information. For example, while normal transmission are not influenced for the services having a relatively low demand for transmission resource, the services having a relatively high demand for transmission resource may be allocated with greater guaranteed bandwidths, such that the transmission performance for service packets can be improved and services can be guaranteed without interruption.

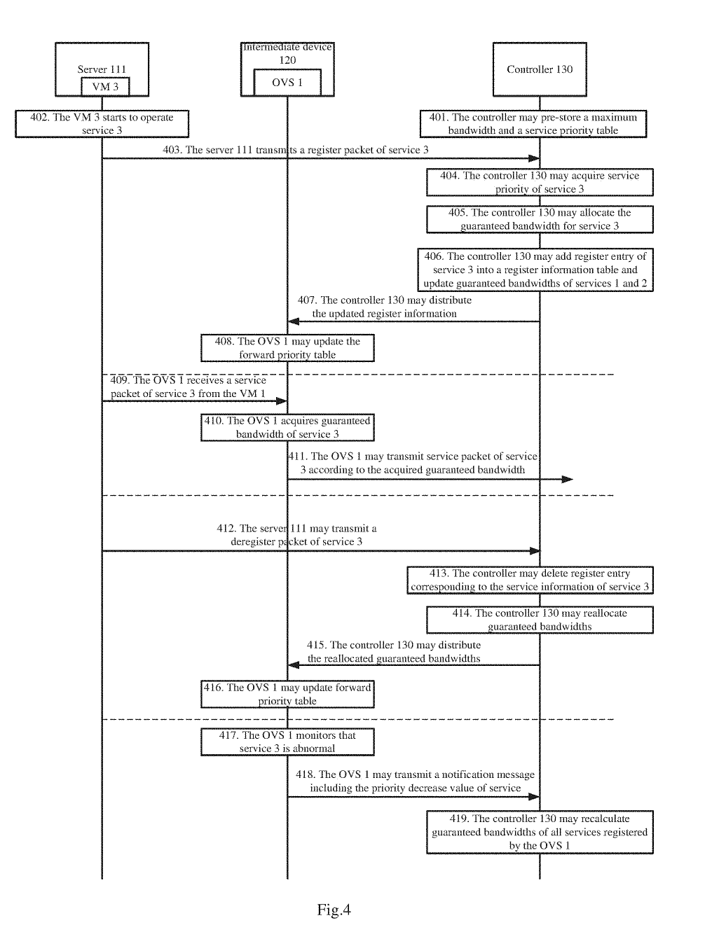

Next, refer to FIG. 3 which is a flowchart illustrating a method for transmitting a packet according to another example of the disclosure. This example gives description from the controller side, and the description may include the following blocks.

At block 301, a register packet may be received from a first intermediate device, wherein the register packet is transmitted to the first intermediate device when the target service on the server starts.

In this example, the controller may be connected with one or more intermediate devices including the first intermediate device, and this example may take the first intermediate device as an example to illustrate the interaction between the first intermediate device with the controller.

When a target service on the server starts, the server may transmit a register packet to the first intermediate device connected therewith, and the first intermediate device may forward the register packet to the controller. The register packet may carry service information of the target service. And wherein, the service information may include the IP address and the MAC address of the server which operates the target service and the port number of the target service.

At block 302, according to the service information of the target service carried in the register packet, a guaranteed bandwidth may be allocated to the target service.

In this example, the controller may be provided thereon with a preset service priority table, and the service priority table may pre-store correspondences between service information and service priorities of different services. And the controller may also be provided thereon with a preset register information table, and the register information table may store correspondences between service information of registered services and allocated guaranteed bandwidths. And wherein, the services registered by the same intermediate device may be identified with a device identity (ID) of the same intermediate device, and the device ID may be, for example, the IP address of the intermediate device.

When receiving a register packet of the target service, the controller may acquire the service priority from a service priority table according to the service information of the target service. And the controller may acquire the service priorities of all services registered on the controller through the first intermediate device from a register information table. Then the controller may calculate a guaranteed bandwidth of the target service according to the maximum bandwidth pre-allocated to the first intermediate device, a service priority of the target service and the service priorities of all the registered services. When calculating the guaranteed bandwidth of the target service, the controller may calculate a sum of the service priority of the target service and the service priorities of all the registered services, then acquire the guaranteed bandwidth of the target service by multiplying the maximum bandwidth with a value obtained by dividing the service priority of the target service by the sum.

At block 303, the guaranteed bandwidth may be distributed to the first intermediate device, so that the first intermediate device may transmit a service packet of the target service according to the allocated guaranteed bandwidth when receiving the service packet.

When the controller distributes the guaranteed bandwidth allocated for the target service to the first intermediate device, the first intermediate device may transmit the service packet of the target service according to the allocated guaranteed bandwidth. Regarding how the first intermediate device transmits the service packet according to the guaranteed bandwidth, it may refer to the above example illustrated in FIG. 2 and its description may be omitted here.

In combination with the above-described example, in an optional manner, when the above-described target service shuts down, the first intermediate device may forward to the controller a deregister packet transmitted from the server. The deregister packet may carry the service information of the target service, and the controller may learn from the deregister packet that the bandwidth for the target service is not necessary to be guaranteed. Then the controller may instruct the first intermediate device to release the guaranteed bandwidth allocated for the target service while the guaranteed bandwidth for a remaining service is unchanged. Here the remaining service includes a service registered on the controller by the intermediate device other than the target service. Or the controller may further reallocate a guaranteed bandwidth for a remaining service according to the service information in the deregister packet. When reallocating a guaranteed bandwidth for the remaining service, the controller may distribute the reallocated guaranteed bandwidth to the first intermediate device, and the first intermediate device may update the corresponding forward entry in the forward priority table according to the reallocated guaranteed bandwidth. When reallocating a guaranteed bandwidth for a remaining service, the controller may determine a register entry of the remaining service registered by the first intermediate device from the register information table, and the register entry of the remaining service may include the guaranteed bandwidth and the service priority of the remaining service. Then the controller may recalculate a guaranteed bandwidth for a remaining service according to the proportion of the service priority of the remaining service in the sum of the service priorities of all remaining services by using the maximum bandwidth of the first intermediate device, current guaranteed bandwidth and the service priority of the remaining service.

In combination with the above-described example, in another example, when the first intermediate device monitors an abnormal service of which the hitting number is not within a preset range, the first intermediate device may transmit a notification message to the controller. Then the controller may adjust the guaranteed bandwidth of the abnormal service according to the notification message, and may further adjust the guaranteed bandwidths of all services of which the service packets are transmitted through the first intermediate device.

In an example, when the controller learns from the notification message that the hitting number of an abnormal service is lower than the lower limit of the preset range, it indicates that the abnormal service has a very little flow or even has no packet flow in a preset period, then the controller may reduce the guaranteed bandwidth of the abnormal service and may further allocate the reduction in the guaranteed bandwidth to other normal services of which service packets are transmitted through the intermediate device. If the notification message carries a service priority reduction value of the abnormal service, the controller may acquire an actual service priority of the abnormal service according to the value. Then the controller may reallocate a guaranteed bandwidth for the abnormal service according to the actual service priority. Or, after receiving the notification message, the controller may also firstly reduce the service priority of the abnormal service by a preset value, and reallocate a guaranteed bandwidth for the abnormal service according to the reduced service priority.

In another example, when the controller learns from the notification message that the hitting number of an abnormal service is higher than the upper limit of the preset range, it indicates that the abnormal service has a relatively large packet flow in the preset period, and thus, the controller may increase the guaranteed bandwidth of the abnormal service and further correspondingly reduce the guaranteed bandwidths of normal services of which service packets are transmitted through the intermediate device. If the notification message carries a service priority increase value of the abnormal service, the controller may acquire an actual service priority of the abnormal service according to the value, and then reallocate a guaranteed bandwidth for the abnormal service according to the actual service priority. Or, after receiving the notification message, the controller may also firstly increase the service priority of the abnormal service by a preset value and then reallocate a guaranteed bandwidth for the abnormal service according to the increased service priority.

In combination with the above-described example, in another optional manner, when the maximum bandwidth of the first intermediate device is changed, e.g., when the maximum bandwidth of the first intermediate device is reallocated by the controller, the controller may reallocate the guaranteed bandwidths for the services registered by the first intermediate device according to the changed maximum bandwidth.

It can be seen from the above-described example that, since the service information may reflect different demands for transmission resource of different services, the controller may allocate proper guaranteed bandwidths for different services according to different demands. For example, while normal transmission of the services having a low demand for transmission resource is not influenced, the controller may allocate a greater guaranteed bandwidth to the service having a high demand for transmission resource, such that the transmission performance for service packets may be improved and services can be guaranteed without interruption.

Next, refer to FIG. 4 which is a flowchart illustrating a method for transmitting a packet according to another example of the disclosure, and this example illustrates a packet transmission process in detail in combination with FIG. 1.

The following blocks 401˜408 illustrate a service registering process.

At block 401, a controller may pre-store maximum bandwidths allocated for different intermediate devices and pre-store a service priority table.

The service priority table may comprise correspondence between service information and service priorities of different services. The service information may include the IP address and the MAC address of the server which operates the service and the port number of the service.

Referring to FIG. 1, the following table 1 illustrates an example of a service priority table. The service priority table may include service priority information of four services operated on VMs 1˜4. Suppose that a first entry represents service 1 operated on the VM 1 on the server 111, a second entry represents service 2 operated on the VM 2 on the server 111, a third entry represents service 3 operated on the VM 3 on the server 111 and a fourth entry represents service 4 operated on the VM 4 on the server 112.

TABLE 1

| MAC | IP | Port Number | Service Priority |
|---|---|---|---|
| 1-1-1 | 1.1.1.1 | 21 | 10 |
| 1-1-1 | 1.1.1.1 | 200 | 30 |
| 1-1-1 | 1.1.1.1 | 5000 | 60 |
| 1-1-2 | 1.1.1.2 | 200 | 50 |

At block 402, the VM 3 on the server 111 starts to operate the service 3 after the VM 3 starts.

At block 403, the server 111 transmits a register packet of the service 3 to the controller 130 by the OVS 1, wherein the register packet carries the port number of the service 3 and the IP address and the MAC address of the server 111.

In this example, the register packet may be a packet conforming to an Open Flow protocol based on SDN. The register packet may have a format of TYPE/LENGTH/VALUE (TLV). The following table 2 illustrates a register packet of a TLV format.

TABLE 2

| TYPE | LENGTH | VALUE |
|---|---|---|
| 01 | 8 | Port Number, IP address, and MAC |
| | | address |

In the above table 2, the TYPE “01” represents that the packet is a “register packet”, the LENGTH “8” represents that the VALUE has a length of 8 bytes, and the VALUE may include the port number of the registered service and the IP address and the MAC address of the server on which the registered service is operated, for example, for service 3, the VALUE is “5000, 1.1.1.1, 1-1-1”.

At block 404, when receiving the register packet of the service 3, the controller 130 may acquire the service priority of the service 3 from the service priority table according to the VALUE in the register packet.

In combination with the table 1, the corresponding service priority “60” may be acquired from the table 1 according to the VALUE “5000, 1.1.1.1, 1-1-1” in the register packet.

At block 405, the controller 130 may allocate the guaranteed bandwidth for the service 3 according to the service priority of the service 3.

In this example, the controller 130 is provided thereon with a register information table for storing register information of all registered services, the register information including correspondence among the service information, the service priority, the allocated guaranteed bandwidth and the corresponding OVS address of the service. The following table 3 is an example of a register information table.

Referring to FIG. 1, suppose that the registered services in table 3 include services 1 and 2 registered by OVS 1 and service 4 registered by OVS 2, and different OVSs may be distinguished from each other through their IP addresses. Taking services 1 and 2 registered by OVS 1 as an example, suppose that the controller 130 has allocated a maximum bandwidth of 1000M for OVS 1 beforehand, the controller 130 may then allocate an guaranteed bandwidth of 250M to the service 1 and an guaranteed bandwidth of 750M to the service 2 according to the ratio (10:30) of the priorities of services 1 and 2.

TABLE 3

| | | | Port | Service | Guaranteed |
|---|---|---|---|---|---|
| OVS address | MAC | IP | Number | Priority | Bandwidth |
| OVS 1 IP 1 | 1-1-1 | 1.1.1.1 | 21 | 10 | 250 |
| OVS 1 IP 1 | 1-1-1 | 1.1.1.1 | 200 | 30 | 750 |
| OVS 2 IP 2 | 1-1-2 | 1.1.1.2 | 200 | 50 | 500 |

In this block, when the controller 130 acquires from the above table 3 that the services 1 and 2 registered by OVS 1 respectively have priorities of 10 and 30, by using the service priority 60 of the service 3 and the maximum bandwidth 1000M of OVS 1, the guaranteed bandwidth may be calculated according to the following equation:

Guaranteed Bandwidth=(Service Priority of Target Service/Sum of Service Priorities of All Registered Services)*Maximum Bandwidth

According to the above equation, the guaranteed bandwidth of the service 3 may be calculated as [60/(10+30+60)]*1000 M=600M.

In the same way, according to the above equation, the guaranteed bandwidths of the services 1 and 2 may be recalculated as 100M, and 300M respectively.

At block 406, the controller 130 may add the register entry of the service 3 into the register information table, and update the guaranteed bandwidths of the services 1 and 2. The following table 4 is an updated register information table based on the table 3.

TABLE 4

| | | | Port | Service | Guaranteed |
|---|---|---|---|---|---|
| OVS address | MAC | IP | Number | Priority | Bandwidth |
| OVS 1 IP 1 | 1-1-1 | 1.1.1.1 | 21 | 10 | 100 |
| OVS 1 IP 1 | 1-1-1 | 1.1.1.1 | 200 | 30 | 300 |
| OVS 1 IP 1 | 1-1-1 | 1.1.1.1 | 5000 | 60 | 600 |
| OVS 2 IP 2 | 1-1-2 | 1.1.1.2 | 200 | 50 | 500 |

At block 407, the controller 130 may distribute the updated register information to the OVS 1.

In combination with the example in block 406, the updated register information distributed by the controller 130 to the OVS 1 may include the register information of the service 1, the service 2 and the service 3 which are registered by the OVS 1.

At block 408, the OVS 1 may update the forward priority table according to the received register information.

The OVS 1 is provided thereon with a forward priority table and each forward entry in the forward priority table may include the register information of all the services registered by the OVS 1 which is distributed from the controller, for example, may include correspondence between the service information and the guaranteed bandwidth. When receiving the updated register information, the OVS 1 may update the forward priority table. The following table 5 is an example of a forward priority table.

TABLE 5

| | | | | Guaranteed |
|---|---|---|---|---|
| MAC | IP | Port Number | Service Priority | Bandwidth |
| 1-1-1 | 1.1.1.1 | 21 | 10 | 100 |
| 1-1-1 | 1.1.1.1 | 200 | 30 | 300 |
| 1-1-1 | 1.1.1.1 | 5000 | 60 | 600 |

The following blocks 409˜411 illustrate a service packet transmission process.

At block 409, the OVS 1 receives a service packet of service 3 from the VM 1, wherein the service packet carries service information including the MAC address and the IP address of the server 111 and the port number of the service 3.

At block 410, the OVS 1 acquires the guaranteed bandwidth from the forward priority table according to the service information.

Suppose that the service packet of the service 3 carries the service information “1-1-1, 1.1.1.1, 5000”, the OVS 1 may acquire the guaranteed bandwidth 600M of the service 3 from the forward priority table as illustrated in the table 5.

At block 411, the OVS 1 may transmit the service packet of the service 3 according to the acquired guaranteed bandwidth.

The following blocks 412˜416 illustrate a service deregistering process.

At block 412, the server 111 may transmit a deregister packet for the service 3 to the controller 130 by the OVS 1, wherein the deregister packet carries the port number of the service 3 and the IP address and the MAC address of the server 111.

In this example, the deregister packet may also be a packet according to an Open Flow protocol based on SDN, and the deregister packet may have a TLV format. The following table 6 illustrates a deregister packet of a TLV format.

TABLE 6

| TYPE | LENGTH | VALUE |
|---|---|---|
| 00 | 8 | Port number, IP address and MAC |
| | | address |

The deregister packet illustrated in the table 6 is different in TYPE from the register packet illustrated in the table 2. For example, the TYPE “00” in the table 6 represents that the packet is a “deregister packet”.

At block 413, the controller 130 may delete the register entry corresponding to the service information of the service 3 carried in the deregister packet from the register information table.

According to the service information of the service 3, that is, the VALUE “5000, 1.1.1.1, 1-1-1” carried in the deregister packet, the controller 130 may delete the register entry corresponding to the service 3 from the register information table as illustrated in the table 4.

At block 414, the controller 130 may reallocate guaranteed bandwidths for the services registered by the OVS 1.

After the register entry of the service 3 is deleted, the OVS 1 no longer needs to allocate the guaranteed bandwidth for the service packet of the service 3, and the controller 130 may reallocate guaranteed bandwidths for the services 1 and 2 registered by the OVS 1. The detailed reallocating process is the same with that in block 405 and its description may be omitted here.

At block 415, the controller 130 may distribute the reallocated guaranteed bandwidths to the OVS1.

At block 416, the OVS 1 may update the forward priority table according to the received guaranteed bandwidths.

It can be learned from the above-described example that, when the OVS 1 receives the guaranteed bandwidths reallocated for the services 1 and 2 by the controller 130, the OVS 1 may update the guaranteed bandwidths in the forward entries corresponding to the services 1 and 2 and delete the forward entry corresponding to the service 3 from the forward priority table as illustrated in the table 5.

The following blocks 417˜419 illustrate a process in which the OVS 1 adjusts the guaranteed bandwidth of the service 3.

At block 417, when the OVS 1 monitors that the hitting number which indicates how many times service packets of the service 3 hit the corresponding forward entry in a preset period is lower than a preset number, the OVS 1 may determine that the service 3 is an abnormal service.

The OVS 1 may determine changes of a packet flow of a service by comparing the hitting number indicating how many times service packets of the service hit the corresponding forward entry in the forward priority table in the preset period with the preset number. For example, the preset period may be 10 minutes, and the preset number may be 1000. Assume that the hitting number indicating how many times service packets of the service 3 hit the forward entry in 10 minutes is 0, and it indicates that the packet flow of the service 3 is 0 in the preset period. At this time, the controller 130 may adjust the guaranteed bandwidth of the service 3 according to a request.

At block 418, the OVS 1 may transmit a notification message including the priority decrease value of the service 3 to the controller 130.

The notification message transmitted from the OVS 1 to the controller 130 may have a packet format as illustrated in the following table 7.

TABLE 7

| TYPE | LENGTH | VALUE |
|---|---|---|
| 03 | 10 | Port number, IP address, MAC address |
| | | and priority decrease value |

In the above table 7, the TYPE “03” represents that the packet is a “notification message”, the LENGTH “10” represents that the VALUE has a length of 10 bytes, and the VALUE may include the port number of the service 3, the IP address and MAC address of the server on which the service 3 is operated and the priority decrease value.

At block 419, the controller 130 may recalculate guaranteed bandwidths of all the services registered by the OVS 1 according to the notification message.

In combination with the above table 7, the service 3 has a VALUE of “5000, 1.1.1.1, 1-1-1, 50”, wherein the “50” represents that the service priority of the service 3 is reduced by 50. Referring to the register information table illustrated in the table 4, the service priority of the service 3 may decrease from 60 to 10. Then the controller 130 may recalculate the guaranteed bandwidths of the services 1, 2 and 3 according to the reduced service priority 10 of the service 3. The specific calculation process may refer to block 405 and will not be described here.

Subsequently, the controller 130 may distribute the recalculated guaranteed bandwidths to the OVS 1, and the OVS 1 may update the corresponding guaranteed bandwidths of the services 1, 2 and 3 in the forward priority table, and the specific process may be omitted here for avoidance of redundancy.

Based on the above example, it can be seen that service information may reflect different demands for transmission resource of different services, and the controller may distribute proper guaranteed bandwidths to different services according to different demands. For example, while normal transmission of services having a low demand for transmission resource is not influenced, services having a high demand for transmission resource may be allocated with greater guaranteed bandwidths, thus the transmission performance for service packets may be improved and service can be guaranteed without interruption.

The disclosure further provides an example of a device for transmitting a packet.

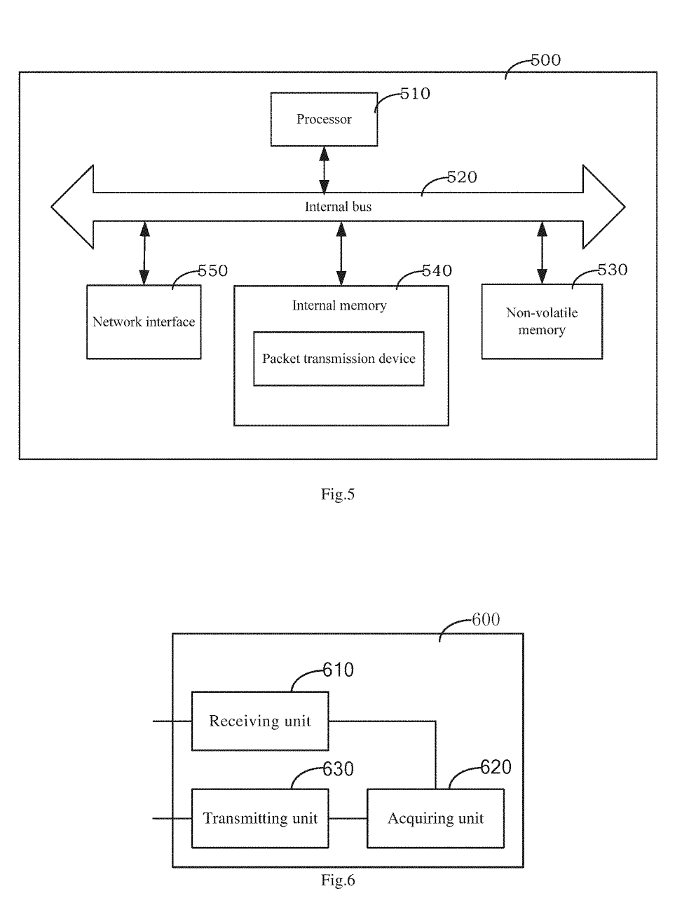

The device for transmitting a packet according to the disclosure may be applied on an intermediate device or a controller. The device for transmitting a packet may be realized through software, and may also be realized through hardware or combination of software and hardware. For example, the device for transmitting a packet may be logically formed by a processor in an apparatus on which the device for transmitting a packet is located by reading out and executing machine executable instructions from a non-volatile storage medium to an internal memory. FIG. 5 illustrates a hardware structure for an apparatus 500 on which the device for transmitting a packet is located. Besides a processor 510, an internal bus 520, a network interface 550, an internal memory 540 and a non-volatile memory 530 illustrated in FIG. 5, the apparatus 500 may further include other hardware, such as a packet forward chip used for processing a packet, which are omitted here.

Next, refer to FIG. 6 which is a block diagram illustrating a device for transmitting a packet according to the disclosure. The device 600 illustrated in FIG. 6 may be applied on an intermediate device in a SDN, and the device 600 may include the following function units.

A receiving unit 610 may receive a service packet of a target service transmitted from a server, wherein the service packet carries service information of the target service.

An acquiring unit 620 may acquire a guaranteed bandwidth corresponding to the service information of the target service.

A transmitting unit 630 may transmit the service packet of the target service according to the guaranteed bandwidth.

In another example, the receiving unit 610 may further receive a register packet of the target service transmitted from the server when the target service starts, wherein the register packet carries the service information of the target service. In this case, the device 600 may further include a transmitting unit (not shown in FIG. 6) which is used to transmit the register packet to the controller such that the controller may allocate the guaranteed bandwidth for the target service according to the service information. Further, the receiving unit 610 may also receive the service information and the guaranteed bandwidth of the target service distributed from the controller.

Further, the device 600 may further include a storing unit (not shown in FIG. 6) used to store a forward entry of the target service in a forward priority table, wherein the forward entry includes correspondence between the service information and the guaranteed bandwidth. In this case, the acquiring unit 620 may determine the forward entry of the target service from the forward priority table according to the service information of the target service and further acquire the guaranteed bandwidth of the target service from the forward entry.

In another example, the receiving unit 610 may further receive a deregister packet of the target service transmitted from the server when the target service shuts down, wherein the deregister packet carries service information of the target service. The transmitting unit may further transmit the deregister packet to the controller such that the controller may reallocate a guaranteed bandwidth for a remaining service according to the service information, wherein the remaining service includes a service registered on the controller by the intermediate device other than the target service. The receiving unit 610 may also receive the guaranteed bandwidth reallocated for the remaining service distributed from the controller. In this case, the device 600 may further include an updating unit (not shown in FIG. 6) used to update a forward entry of the remaining service in the forward priority table according to the reallocated guaranteed bandwidth.

In another example, the device 600 may further include a monitoring unit (not shown in FIG. 6) used to monitor the hitting number indicating how many times service packets of different services hit corresponding forward entry in the forward priority table in a preset period. In this case, the transmitting unit may further transmit a notification message to the controller when the monitoring unit monitors an abnormal service of which the hitting number is not within a preset range in the preset period, such that the controller may adjust the guaranteed bandwidth of the abnormal service according to the notification message.

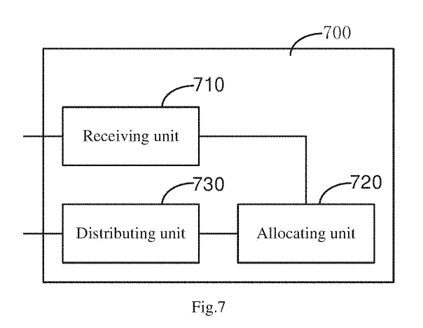

Next, refer to FIG. 7 which is another block diagram illustrating a device for transmitting a packet according to another example of the disclosure. The device 700 may be applied on a controller in a SDN and may include the following units.

A receiving unit 710 may receive a register packet transmitted from the first intermediate device, wherein the register packet is transmitted to the first intermediate device when a target service on a server starts.

An allocating unit 720 may allocate a guaranteed bandwidth for the target service according to service information of the target service carried in the register packet.

A distributing unit 730 may distribute the guaranteed bandwidth to the first intermediate device such that the first intermediate device may transmit a service packet of the target service according to the guaranteed bandwidth when receiving the service packet.

In another example, the allocating unit 720 may include the following function units (not shown in FIG. 7).

A first lookup subunit may acquire a service priority of the target service from a preset service priority table according to the service information.

A second lookup subunit may acquire service priorities of all services registered on the controller by the first intermediate device from a register information table.

A bandwidth calculating subunit may calculate a guaranteed bandwidth of the target service according to maximum bandwidth of the first intermediate device, the service priority of the target service and the service priorities of all the services registered on the controller.

In another example, the receiving unit 710 may also receive a deregister packet transmitted from the first intermediate device, wherein the deregister packet is transmitted to the first intermediate device when the target service shuts down. The allocating unit 720 may also reallocate a guaranteed bandwidth for a remaining service according to service information of the target service carried in the deregister packet, wherein the remaining service includes a service registered on the controller by the first intermediate device other than the target service. The distributing unit 730 may also distribute the reallocated guaranteed bandwidth to the first intermediate device.

In another example, the allocating unit 720 may include the following function units (not shown in FIG. 7).

An entry deleting subunit may delete a register entry of the target service from a register information table according to service information of the target service.

An entry lookup subunit may determine a register entry of a remaining service registered on the controller by the first intermediate device from the register information table, wherein the register entry of the remaining service includes a guaranteed bandwidth and service priority of the remaining service.

A bandwidth calculating subunit may calculate the guaranteed bandwidth reallocated for the remaining service according to the maximum bandwidth of the first intermediate device, and current guaranteed bandwidth and service priority of the remaining service.

In another example, the receiving unit 710 may also receive a notification message transmitted from the first intermediate device, wherein the notification message is transmitted when the first intermediate device monitors an abnormal service of which the hitting number is not within a preset range, wherein the hitting number of a service indicates how many times the forward entry in a forward priority table corresponding to the service is hit by service packets of the service in a preset period. The allocating unit 720 may also adjust the guaranteed bandwidth of the abnormal service according to the notification message.

The specific processes about the above-described units/subunits may refer to the description about the corresponding blocks in the above-described method according to the disclosure, and are not described here.

Since the above-mentioned device correspond to the method for transmitting a packet, the detailed description about the examples of the device may refer to the examples of the method for transmitting a packet. The above-described device is merely illustrative, wherein, the units described as separate components may be or may be not physically separate from each other, and the components illustrated as the units may be or may be not physical units, for example, these units may be integral or distributed to a plurality of network units. Part or all of the modules/units/blocks may be selected to realize the disclosure according to practical needs, and those having ordinary skill in the art may readily understand and practice the disclosure without creative work.

It can be seen from the above examples that, since service information may reflect different demands for transmission resources of different services, the controller may allocate a proper guaranteed bandwidth to each of the services according to their different demands. While guaranteeing the normal transmission of service packets having a relatively low demand for transmission resource, services having a relatively high demand for transmission resource may be allocated with relatively greater guaranteed bandwidths, thus the transmission performance for service packets may be improved and services can be guaranteed without interruption.

Other examples of the disclosure will be apparent to those skilled in the art upon reading the description and practicing the above-described examples of the disclosure. The disclosure is intended to encompass all modifications, use or adaptive variations to the described examples of the disclosure, wherein these modifications, use or adaptive variations shall comply with the general principle of the disclosure and may include common knowledge or customary technical means in the art which are not mentioned herein. Further, the Description and the described examples shall be viewed as exemplary, and the scope and spirit of the disclosure shall be defined only by the appended claims.

Besides, it shall be understood that, the disclosure is not limited to the specific structures described above and illustrated in the attached figures, and various modifications and changes can be made without departing from the scope of the disclosure, which is defined only by the appended claims.

1. A method for transmitting a packet, including:
receiving, by an intermediate device in a software defined network (SDN), a service packet of a target service from a server in the SDN, wherein the service packet carries service information of the target service;
acquiring, by the intermediate device, a guaranteed bandwidth corresponding to the service information of the target service; and
transmitting, by the intermediate device, the service packet of the target service according to the guaranteed bandwidth.

2. The method according to claim 1, wherein, acquiring the guaranteed bandwidth corresponding to the service information of the target service, includes:
receiving, by the intermediate device, a register packet of the target service from the server when the target service starts, wherein, the register packet carries the service information of the target service;
transmitting, by the intermediate device, the register packet to a controller of the SDN such that the controller allocates the guaranteed bandwidth for the target service according to the service information;
receiving, by the intermediate device, the service information and the guaranteed bandwidth of the target service distributed from the controller;
storing, by the intermediate device, a forward entry of the target service in a forward priority table, wherein the forward entry includes correspondence between the service information and the guaranteed bandwidth; and
determining, by the intermediate device, the forward entry of the target service from the forward priority table according to the service information of the target service, so as to acquire the guaranteed bandwidth of the target service from the forward entry.

3. The method according to claim 2, further including:
receiving, by the intermediate device, a deregister packet of the target service from the server when the target service shuts down, wherein the deregister packet carries the service information of the target service;
transmitting, by the intermediate device, the deregister packet to the controller such that the controller reallocates a guaranteed bandwidth for a remaining service according to the service information carried in the deregister packet, wherein the remaining service includes a service registered on the controller by the intermediate device other than the target service;
receiving, by the intermediate device, the reallocated guaranteed bandwidth for the remaining service distributed from the controller; and
updating, by the intermediate device, the forward entry of the remaining service in the forward priority table according to the reallocated guaranteed bandwidth.

4. The method according to claim 2, further including:
monitoring, by the intermediate device, a hitting number for each of different services, wherein, the hitting number for a service indicates how many times the forward entry in the forward priority table corresponding to the service is hit by service packets of the service in a preset period; and
when monitoring an abnormal service of which the hitting number is beyond a preset range, transmitting, by the intermediate device, a notification message to the controller such that the controller adjusts the guaranteed bandwidth of the abnormal service according to the notification message.

5. A method for transmitting a packet, including:
receiving, by a controller in a software defined network (SDN), a register packet for a target service on a sever in the SDN from an intermediate device in the SDN, wherein the register packet is transmitted to the intermediate device when the target service starts;
allocating, by the controller, a guaranteed bandwidth for the target service according to service information of the target service carried in the register packet; and
distributing, by the controller, the guaranteed bandwidth to the intermediate device, such that the intermediate device transmits a service packet of the target service according to the guaranteed bandwidth.

6. The method according to claim 5, wherein, allocating the guaranteed bandwidth for the target service according to the service information of the target service carried in the register packet, includes:
acquiring, by the controller, a service priority of the target service from a preset service priority table according to the service information;
acquiring, by the controller, service priorities of all services registered on the controller by the intermediate device from a register information table; and
calculating, by the controller, a guaranteed bandwidth of the target service according to a maximum bandwidth of the intermediate device, the service priority of the target service and the service priorities of all the services registered on the controller.

7. The method according to claim 6, wherein, calculating the guaranteed bandwidth of the target service, includes:
calculating, by the controller, a sum of the service priority of the target service and the service priorities of all the services registered on the controller; and
acquiring, by the controller, the guaranteed bandwidth of the target service by multiplying the maximum bandwidth with a value obtained by dividing the service priority of the target service by the sum.

8. The method according to claim 5, further including:
receiving, by the controller, a deregister packet for the target service from the intermediate device, wherein the deregister packet is transmitted to the intermediate device when the target service shuts down;
reallocating, by the controller, a guaranteed bandwidth for a remaining service according to the service information of the target service carried in the deregister packet, wherein the remaining service includes a service registered on the controller by the intermediate device other than the target service; and
distributing, by the controller, the reallocated guaranteed bandwidth to the intermediate device.

9. The method according to claim 8, wherein, reallocating the guaranteed bandwidth for the remaining service according to the service information of the target service carried in the deregister packet, includes:
deleting, by the controller, a register entry of the target service from a register information table according to the service information of the target service;
determining, by the controller, a register entry of the remaining service registered on the controller by the intermediate device from the register information table, wherein the register entry of the remaining service includes a guaranteed bandwidth and a service priority of the remaining service; and
calculating, by the controller, the guaranteed bandwidth reallocated for the remaining service according to a maximum bandwidth of the intermediate device and current guaranteed bandwidth and the service priority of the remaining service.

10. The method according to claim 5, further including:
receiving, by the controller, a notification message from the intermediate device, wherein the notification message is transmitted when the intermediate device monitors an abnormal service of which a hitting number is beyond a preset range, wherein the hitting number of a service indicates how many times the forward entry in a forward priority table corresponding to the service is hit by service packets of the service in a preset period; and
adjusting, by the controller, a guaranteed bandwidth of the abnormal service according to the notification message.

11. A device for transmitting a packet, which is applied on an intermediate device in a software defined network (SDN), including:
a receiving unit to receive a service packet of a target service from a server in the SDN, wherein the service packet carries service information of the target service;
an acquiring unit to acquire a guaranteed bandwidth corresponding to the service information of the target service; and
a transmitting unit to transmit the service packet of the target service according to the guaranteed bandwidth.

12. The device according to claim 11, further including a transmitting unit and a storing unit, wherein,
the receiving unit receives a register packet of the target service from the server when the target service starts, wherein the register packet carries the service information of the target service;
the transmitting unit transmits the register packet to a controller of the SDN such that the controller allocates the guaranteed bandwidth for the target service according to the service information of the target service;
the receiving unit receives the service information and the guaranteed bandwidth of the target service distributed from the controller;
the storing unit stores a forward entry of the target service in a forward priority table, wherein the forward entry includes correspondence between the service information and the guaranteed bandwidth; and
the acquiring unit determines the forward entry of the target service from the forward priority table according to the service information of the target service, so as to acquire the guaranteed bandwidth of the target service from the forward entry.

13. The device according to claim 12, further including an updating unit, wherein,
the receiving unit receives a deregister packet of the target service from the server when the target service shuts down, wherein the deregister packet carries the service information of the target service;
the transmitting unit transmits the deregister packet to the controller such that the controller reallocates a guaranteed bandwidth for a remaining service according to the service information carried in the deregister packet, wherein the remaining service includes a service registered on the controller by the intermediate device other than the target service; and
the receiving unit receives the reallocated guaranteed bandwidth for the remaining service distributed from the controller; and
the updating unit updates the forward entry of the remaining service in the forward priority table according to the reallocated guaranteed bandwidth.

14. The device according to claim 12, further including a monitoring unit, wherein,
the monitoring unit monitors a hitting number for each of different services, wherein, the hitting number for a service indicates how many times the forward entry in the forward priority table corresponding to the service is hit by service packets of the service in a preset period; and
when the monitoring unit monitors an abnormal service of which the hitting number is beyond a preset range, the transmitting unit transmits a notification message to the controller such that the controller adjusts the guaranteed bandwidth of the abnormal service according to the notification message.

15. A device for transmitting a packet, which is applied on a controller in a software defined network (SDN), including:
a receiving unit to receive a register packet for a target service on a server in the SDN from an intermediate device in the SDN, wherein the register packet is transmitted to the intermediate device when the target service starts;
an allocating unit to allocate a guaranteed bandwidth for the target service according to service information of the target service carried in the register packet; and
a distributing unit to distribute the guaranteed bandwidth to the intermediate device, such that the intermediate device transmits a service packet of the target service according to the guaranteed bandwidth.

16. The device according to claim 15, wherein, the allocating unit includes:
a first lookup subunit to acquire a service priority of the target service from a preset service priority table according to the service information;
a second lookup subunit to acquire service priorities of all services registered on the controller by the intermediate device from a register information table; and
a bandwidth calculating subunit to calculate a guaranteed bandwidth of the target service according to a maximum bandwidth of the intermediate device, the service priority of the target service and the service priorities of all the services registered on the controller.

17. The device according to claim 15, wherein,
the receiving unit receives a deregister packet for the target service from the intermediate device, wherein the deregister packet is transmitted to the intermediate device when the target service shuts down;
the allocating unit reallocates a guaranteed bandwidth for a remaining service according to the service information of the target service carried in the deregister packet, wherein the remaining service includes a service registered on the controller by the intermediate device other than the target service; and
the distributing unit distributes the reallocated guaranteed bandwidth to the intermediate device.

18. The device according to claim 15, wherein,
the receiving unit receives a notification message from the intermediate device, wherein the notification message is transmitted when the intermediate device monitors an abnormal service of which a hitting number is beyond a preset range, wherein the hitting number of a service indicates how many times the forward entry in a forward priority table corresponding to the service is hit by service packets of the service in a preset period; and
the allocating unit adjusts a guaranteed bandwidth of the abnormal service according to the notification message.
